(19) United States
(12) Patent Application Publication
(10) Pub. No.: US 2008/0181990 A1
(43) Pub. Date: Jul. 31, 2008

(54) Compositions comprising wheat protein isolate and related methods

(76) Inventors: Kati R. Ledbetter, Mt. Zion, IL (US); Charles E. Werstak, Normal, IL (US)

Correspondence Address: KIRKPATRICK & LOCKHART PRESTON GATES ELLIS LLP;HENRY W. OLIVER BUILDING, 535 SMITHFIELD STREET, PITTSBURGH, PA, 15222, US

(21) Appl. No.: 12/011,067

(22) Filed: Jan. 24, 2008

Related U.S. Application Data
(60) Provisional application No. 60/886,774, filed on Jan. 26, 2007.

(51) Int. Cl. A23L 1/39; A23L 1/035; A23L 1/305; A23D 7/00; B65D 85/72

(52) U.S. Cl. 426/87; 426/656; 426/589; 426/541; 426/548; 426/601

(57) ABSTRACT

The present disclosure provides food compositions and edible emulsions including a wheat protein isolate or a whole bean powder, an edible oil, and water. Processes for producing the food compositions are also disclosed.

### CROSS REFERENCE TO RELATED APPLICATIONS

The application claims the priority benefit of U.S. Provisional Patent Application No. 60/886,774, filed Jan. 26, 2007, the disclosure of the entirety of which is incorporated by this reference.

### TECHNOLOGICAL FIELD

The present disclosure is directed to compositions comprising a wheat protein isolate, an edible oil, and water. Also disclosed are processes of producing food products.

### BACKGROUND

Dressings and spreads, such as, spoonable salad dressings and mayonnaise-type spreads, are popular condiments for foods, such as, for example, sandwiches, salads and the like. Mayonnaise is an edible emulsion of vegetable oil and water along with other ingredients, including an egg protein-based agent. The United States Food and Drug Administration (“FDA”) states that mayonnaise-type spreads may contain vegetable oil, acidulants, egg yolk-containing ingredients, and optionally, other ingredients, such as spices, preservatives, and/or crystallization inhibitors (21 C.F.R. § 169.140(a)). The FDA describes salad dressing as the emulsified semisolid food prepared from vegetable oil(s), an acidulant, an egg yolk-containing ingredient and a starchy paste (21 C.F.R. § 169.150(a)).

The egg protein-based agent in commercially available dressings and spreads, such as, spoonable mayonnaise-type dressings or spreads, may serve as an emulsifying agent to stabilize the oil/water emulsion as well as impart a desirable flavor and texture to the dressing or spread. However, egg-based agents may possess undesirable characteristics making their inclusion in the formulation problematic. For example, due to problems with egg allergies, medical problems associated with cholesterol levels in eggs, religious restrictions/convictions, culinary preferences (such as, for example, a vegetarian or a vegan diet), cost fluctuations in the price of eggs, use of antibiotics and hormones in poultry production, and diseases associated with poultry (such as, for example, bird flu), the use of alternative proteinaceous emulsifying agents may be desired.

Wheat flour contains storage proteins which form a strong, cohesive dough when mixed with water. The wheat proteins may be isolated from wheat flour by removing starch and albumins/globulins by gently working the dough under a stream of water. After washing, a rubbery ball remains comprising the wheat gluten proteins, which are known as “vital wheat gluten”. Traditionally, gluten proteins have been classified into four families according to their solubility: albumins, which are soluble in water or dilute salt solutions and are coagulated by heat; globulins, which are insoluble in pure water but soluble in dilute aqueous salt solutions and insoluble in concentrated aqueous salt solutions; prolamins, which are soluble in aqueous alcohol; and glutelins, which are soluble in dilute acid or bases; detergents; or dissociating or reducing agents, such as urea or 2-mercaptoethanol, respectively.

The prolamins are considered to be unique to the seed of cereals and other grains or grasses. The prolamins have been given different names in different cereals, such as: gliadin in wheat, avenins in oats, zeins in maize, secalins in rye, and hordein in barley. The gliadins and glutenins of wheat are the storage proteins of the wheat endosperm. Gluten can be described as having a bimodal distribution between gliadin and glutenin. Gluten composition is a major factor in determining wheat dough mixing strength and processing characteristics.

Gliadin, or the gliadin fraction of gluten, has a low ionic strength and excellent film forming properties. Gliadin is insoluble in water; however, its solubility may be modified with the addition of a surfactant and/or adjustment of the pH by acidification. Typical acids suitable for solubilizing Gliadin include citric acid, malic acid, lactic acid, oxalic acid, tartaric acid, ascorbic acid, and acetic acid. Gliadin may absorb up to twice its weight of water.

Glutenin, or the glutenin fraction of gluten, is highly elastic and rubbery and is also resistant to shear. Glutenin is insoluble in alcohol and neutral water; however, its solubility may be modified with the addition of a surfactant and/or adjustment of the pH. The protein structure of glutenin is stabilized by interchain disulfide bonds.

Vital wheat gluten is approved by the FDA as Generally Recognized as Safe (“GRAS”) under 21 C.F.R. § 184.1322 for use as a dough strengthener, formulation aid, nutrient supplement, processing aid, stabilizer and thickener, surface finishing agent, and texturizing agent at levels not to exceed current good manufacturing practice.

Through further removal of non-protein constituents, the protein content of vital wheat gluten can be increased. The functional properties of this protein can be modified through the use of acids, reducing agents, phosphates, enzymes, and combinations of any thereof to convert the proteins to a “wheat protein isolate”. The wheat protein isolates have been used in bakery systems for a variety of functions including increasing dough extensibility, decreasing dough mix time, increasing sheeting ability, and increasing protein content, as well as for increasing laminating performance of dough systems.

As used herein, the terms “emulsifier”, “emulgent”, and “surfactant” include a substance which stabilizes an emulsion. Egg yolks may act as food emulsifiers where the main emulsifying chemical is the phospholipid lecithin. For example, both mayonnaise and Hollandaise sauce are oil-in-water emulsions stabilized with egg yolk lecithin. However, as discussed herein, due to a variety of reasons, egg-based emulsifiers may not be desirable.

Egg-free dressings and spreads, including spoonable salad dressings, mayonnaises, and mayonnaise substitutes where the egg protein-based emulsifying agent is reduced or replaced with a proteinaceous emulsifier, such as soy protein, egg-white protein, or whey protein are known. However, these egg-free dressings and spreads may not satisfactorily reproduce the texture and flavor associated with egg-containing dressings and spreads.

### SUMMARY

Various embodiments of the present disclosure provide compositions such as mayonnaise substitutes, spreads, and salad dressings having reduced amounts of egg protein.

In one embodiment, the present disclosure provides a composition comprising a wheat protein isolate, an edible oil, and water. In certain embodiments, the composition may be in the form of a dressing a mayonnaise substitute, or a spread.

In other embodiments, the present disclosure provides a process for producing a food product. The process may comprise mixing a dry mix comprising wheat protein isolate with water, thus forming a protein slurry; and blending an edible oil into the protein slurry, thus forming the food product.

In still other embodiments, the present disclosure provides a food composition configured as a dressing or spread. The food composition comprises 1% to 5% by weight of a wheat protein isolate, 5% to 75% by weight of an edible oil, and 15% to 50% by weight of water. The food composition may further comprise from 1% to 5% by weight of another protein isolate, such as, for example, a whey protein isolate.

Further embodiments of the present disclosure provide food compositions configured as a mayonnaise substitute. The food composition comprises 1% to 5% by weight of a blend of a wheat protein isolate and a whey protein isolate, 45% to 75% by weight of an edible oil, and 15% to 50% by weight of water.

Still further embodiments of the present disclosure provide food compositions configured as a mayonnaise substitute. The food composition comprises 1% to 5% by weight of a wheat protein isolate, 15% to 50% by weight of an edible oil, and 10% to 50% by weight of water.

Other embodiments of the present disclosure provide a composition comprising at least one of a wheat protein isolate and a whole bean powder, an edible oil, and water. The composition may be substantially free of egg protein.

Still other embodiments of the present disclosure provide a composition configured as a dressing, a mayonnaise substitute, or a spread. The composition comprises a whole bean powder, an edible oil, and water.

### DETAILED DESCRIPTION

Various embodiments of the present disclosure provide a composition comprising a wheat protein isolate, an edible oil, and water. The composition may be an edible emulsion in the form of a dressing, such as a spoonable salad dressing, a mayonnaise substitute, or a spread. Other embodiments provide for a process for producing a food product, wherein the food product is a dressing, a mayonnaise substitute, or a spread.

Other than the operating examples, or where otherwise indicated, all numbers expressing quantities of ingredients, processing conditions and the like used in the specification and claims are to be understood as being modified in all instances by the term “about”. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical values, however, may contain certain errors, such as, for example, equipment and/or operator error, necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of less than or equal to 10.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary non-limiting embodiments. It is understood, however, that the invention embraces numerous alternative embodiments, which may be accomplished by combining any of the different features, aspects, and embodiments described herein in any combination that one of ordinary skill in the art would find useful.

According to various embodiments of the present disclosure, a composition comprising a stable edible emulsion may be formed from a wheat protein isolate as an emulsifying agent to stabilize an emulsion between water and an edible oil. For example, according to certain embodiments, the present disclosure describes a composition comprising a wheat protein isolate, an edible oil, and water. The wheat protein isolate, edible oil and water may be in amounts such that the composition may have the form of a dressing, such as a spoonable dressing, a mayonnaise substitute, or a spread. As used herein, the term “mayonnaise substitute” includes spoonable edible emulsions comprising water and edible oil having properties, such as, for example, texture, stability, and flavor, similar to mayonnaise in which the egg-protein based emulsifying agent in a conventional mayonnaise has been reduced or replaced, at least in part, with a wheat protein isolate-based emulsifying agent and/or a whole bean powder emulsifying agent. As used herein, the terms “dressing” and “spread” include spoonable edible emulsions comprising water and edible oil which may be used as, for example, but not limited to, a sandwich spread or a salad dressing. Certain spoonable dressings, such as, for example, mayonnaise, may be described as a Bingham plastic which defines the rheology of the dressing. Thus, the spoonable dressing behaves like a solid until a particular shear stress is applied, after which point if flows like a liquid. The yield value defines the force required to change the product from a solid to a liquid state.

According to the various embodiments of the present disclosure, the wheat protein isolate of the composition may be a modified wheat protein isolate. Commercially available wheat protein isolate compositions include, but are not limited to, PROLITE® brand wheat protein isolates, including, but not limited to, PROLITE® 100 and PROLITE®200 (commercially available from Archer-Daniels-Midland Company, Decatur, Ill.). Other suitable wheat protein isolates which may be used include, but are not limited to, ARISE® brand wheat protein isolates (commercially available from Midwest Grain Products, Atchison, Kans.), GEMTEC brand wheat protein isolates (commercially available from Manildra Milling Corporation, Shawnee Mission, Kans.), and MERIPRO brand wheat protein isolates (commercially available from Tate and Lyle, Decatur, Ill.). According to certain embodiments, the wheat protein isolate may comprise wheat gluten which has been treated with an acid, an enzyme, and/or a reducing agent. According to other embodiments, the wheat protein isolate may be a sulfite-free wheat protein isolate. Examples of suitable sulfite-free wheat protein isolates and methods of making them are disclosed in U.S. Provisional Application No. 60/911,617 incorporated in its entirety by reference herein.

According to certain embodiments, the compositions of the present disclosure may further comprise, in addition to the wheat protein isolate, a protein selected from the group consisting of whey protein, soy protein, whole soybean protein, milk protein, safflower protein, canola protein, an egg protein, isolates of any thereof, concentrates of any thereof, and combinations of any thereof. According to certain embodiments, the composition may comprise a blend of a wheat protein isolate and a whey protein isolate. As used herein, “whey protein isolates” include products comprising whey proteins that have been treated to remove the fat, lactose, and carbohydrates. Suitable whey protein isolates include, but is not limited to, PROVON® 190, commercially available from Glanbia Nutritionals, Monroe, Wis. For example, according to certain embodiments, the composition may comprise substantially equal amounts of a wheat protein isolate and a whey protein isolate. In certain embodiments, such as a full fat mayonnaise substitute, a combination of wheat protein isolate and whey protein isolate may result in a stable emulsion of the edible oil and water. According to other embodiments, the compositions of the present disclosure may comprise whole soybean protein, such as, but not limited to MIDLAND HARVEST® whole soybean powder, commercially available from Archer-Daniels-Midland, Decatur, Ill.

For example, for compositions having lower levels of fat, the composition may comprise the wheat protein isolate as the proteinaceous emulsifier. According to the FDA, mayonnaise-type emulsions must contain a minimum of 65% vegetable oil, by weight (21 C.F.R. § 169.140(a)). Therefore, as used herein, phrases such as “lower levels of fat” or “reduced fat” when used in reference to a composition includes levels of fat, such as vegetable oil or other edible oil, at levels less than 65% by weight. In certain embodiments comprising a wheat protein isolate as the emulsifier, acceptable viscosity levels may be observed with reduced levels of edible oil (i.e., less than 65% edible oil, by weight), thus producing a “reduced-fat” dressing, spread, or mayonnaise substitute.

Alternatively, according to other embodiments, compositions comprising wheat protein isolate as an emulsifier, along with a second proteinaceous emulsifier, such as, for example, whey protein isolate, may demonstrate acceptable viscosity with higher levels of edible oil, thus producing a “higher-fat” dressing, spread or mayonnaise substitute (i.e., minimum of 65% edible oil, by weight). Thus, the various embodiments of the present disclosure include a composition comprising wheat protein isolate as the primary proteinaceous emulsifying agent, whereas other embodiments include a composition comprising wheat protein isolate with at least one other proteinaceous emulsifying agent. According to certain embodiments, the composition may comprise a wheat protein isolate and a whey protein isolate as the emulsifiers.

According to certain embodiments, the edible oil of the compositions may comprise a vegetable oil or an animal fat. Vegetable oils and animal fats include triacylglycerides, which are fatty acid tri-esters of glycerol. Various non-limiting triacylglycerol fats or oils suitable for use in the present disclosure include vegetable-based oils, such as, but not limited to, corn oil, soybean oil, canola oil, vegetable oil, safflower oil, sunflower oil, nasturtium seed oil, mustard seed oil, olive oil, sesame oil, peanut oil, cottonseed oil, rice bran oil, babassu nut oil, castor oil, palm oil, palm kernel oil, rapeseed oil, low erucic acid rapeseed oil, lupin oil, jatropha oil, coconut oil, flaxseed oil, evening primrose oil, jojoba oil, cocoa butter, fractions of any thereof, and mixtures of any thereof. According to other embodiments, the edible oil may have a reduced content of trans-fatty acid ester residues or no trans-fatty acid ester residues.

According to other embodiments, the edible oil may comprise a diacylglycerol (“DAG”) oil. As used herein, the term “diacylglycerol oil” includes acylglycerides in which only two of the three alcohol moieties of glycerol have been esterified with a fatty acid residue. DAG oils can have a structure where the fatty acid residues are connected to adjacent alcohol moieties of the glycerol, i.e., a 1,2-diacylglyceride, or where the fatty acid residues are connected on the primary alcohol moieties of the glycerol, i.e., a 1,3-diacylglyceride. Edible oils comprising high concentrations of DAG have been found to meet consumer demands for a healthier alternative to fats and oils comprising primarily triacylglycerides, while still providing the desired properties of oils, such as for cooking and flavoring foods. One example of an edible oil comprising a high concentration of DAG suitable for use in certain embodiments of the compositions of the present disclosure is ENOVA® brand oil, commercially available from ADM Kao LLC, Decatur, Ill. According to certain embodiments, DAG oils possessing a high content of unsaturated fatty acid residues may be used as the edible oil.

According to various embodiments, the compositions of the present disclosure may comprise a wheat protein isolate, wherein the wheat protein isolate comprises from 1% to 10% by weight of the composition. According to other embodiments, the composition may comprise the wheat protein isolate in an amount of from 1% to 5% by weight.

As described herein, the amount of wheat protein isolate included in the composition may be dependent, for example, on the amount of edible oil included in the composition, the type of edible oil included in the composition, and/or the presence of other additive, for example, whey protein isolate, in the composition. For example, according to certain embodiments wherein the edible oil comprises greater than 65% by weight of the composition, the composition may comprise a substantially equal amount of wheat protein isolate and whey protein isolate. According to certain embodiments, the amount of protein isolate (i.e., combined wheat protein and whey protein) may range from about 1% to 5% by weight of the composition.

According to various embodiments, the compositions of the present disclosure may comprise an edible oil, wherein the edible oil comprises from 5% to 75% by weight of the composition. The amount of the edible oil may be varied according to whether a full-fat composition, a reduced-fat, or a low-fat composition is desired.

As described herein, a full-fat composition includes compositions which comprise greater than or equal to 65% by weight of the edible oil. For example, certain mayonnaise substitutes according to various embodiments herein, such as, for example, an egg-free mayonnaise substitute, may comprise from 65% to 75% by weight of the edible oil. As described herein the edible oil may be any of the edible oils described herein, including triacylglycerol oils, DAG oils, and mixtures thereof. According to other embodiments, the edible oil may comprise a low or reduced trans-fatty acid content oil. In other embodiments, the edible oil may comprise an oil having no trans-fatty acid residues.

As described herein, a reduced-fat composition includes compositions which comprise less than 65% by weight of the edible oil. For example, certain reduced-fat salad dressings or mayonnaise substitutes according to various embodiments, including, for example, egg-free salad dressings and egg-free mayonnaise substitutes may comprise from 5% to 64% by weight of the edible oil. In one non-limiting example of a reduced-fat egg-free mayonnaise substitute or salad dressing, the edible oil may comprise from 20% to 40% by weight of the composition. According to another non-limiting example of a reduced-fat egg-free mayonnaise substitute or salad dressing, the edible oil may comprise from 25% to 35% by weight of the composition.

In certain embodiments of the compositions described herein, the wheat protein isolate may comprise from 1% to 5% by weight of the composition; the edible oil may comprise from 5% to 75% by weight of the composition; and the water may comprise from 15% to 50% by weight of the composition. According to certain embodiments, the composition may be a full-fat mayonnaise substitute comprising from 1% to 5% by weight of a blend of a wheat protein isolate and a whey protein isolate; 45% to 75% by weight of an edible oil; and 15% to 50% by weight of water. In another embodiment, the composition may be a reduced-fat mayonnaise substitute or salad dressing comprising from 1% to 5% by weight of a wheat protein isolate; 15% to 50% by weight of an edible oil; and 10% to 50% by weight of water.

The compositions of the present disclosure may further comprise other ingredients, such as, for example, food starches, sweeteners, acidulants, spices, seasonings, food pieces, stabilizers, antioxidants, sterols, soluble fiber, gums, emulsifiers, flavorings, whole soybean powder, preservatives, colorants, and various combinations of any thereof.

According to certain embodiments, the composition may further comprise an acidulant. The acidulant may be, for example, vinegar, lemon juice, lime juice, citric acid, ascorbic acid, malic acid, fumaric acid, lactic acid, adipic acid, acetic acid, benzoic acid, tartaric acid, and combinations of any thereof. According to certain embodiments, the acidulant may be effective as a preservative as well as to give a characteristic tartness to the composition. For example, according to FDA regulations, “real mayonnaise” may contain at least 2.5% by weight of acetic acid (21 C.F.R. § 169.140(b)(1)). In addition to the preservative and tartness effects described herein, acidulants such as vinegar, lemon juice, and/or lime juice may have desirable effects on the flavor of the composition.

According to certain embodiments, the acidulant may comprise a vinegar, such as, for example, distilled vinegar, white distilled vinegar, wine vinegar (e.g., rice wine vinegar, red wine vinegar and/or white wine vinegar), apple cider vinegar, malt vinegar, balsamic vinegar, fruit vinegar, herbal vinegar (such as, but not limited to, tarragon vinegar), or combinations of any thereof. Vinegars are commercially available as approximately 5% by weight aqueous solutions of acetic acid, however, solutions having higher concentrations of acetic acid, for example, from 10% to 30% acetic acid by weight, are used in industrial and commercial processes and may also be used in certain embodiments herein.

According to other embodiments, the acidulant may comprise lemon juice and/or lime juice. In addition to providing acidity and tartness to the composition, the lemon juice and/or lime juice may also act as a flavorant in the composition. In still other embodiments, the acidulant may comprise a mixture of acidic compounds, such as, but not limited to: a mixture of vinegar and lemon juice, a mixture of vinegar and lime juice, a mixture of vinegar, lemon juice and lime juice, and a mixture of lemon juice and lime juice.

In certain embodiments, the acidulant may be present in an amount ranging from 0% to 15% by weight. In other embodiments, the acidulant may be present in amounts ranging from 2% to 15% by weight, and in other embodiments in amounts ranging from 2% to 10% by weight. In other embodiments the acidulants may be present in amounts ranging from 10% to 15% by weight. The amount of acidulant utilized in the various compositions of the present disclosure may depend, for example, on the amount of edible oil in the composition. For example, full fat dressings or mayonnaise substitutes (i.e., greater than 65% edible oil) may comprise from 4% to 10% acidulant by weight, whereas reduced fat dressings and mayonnaise substitutes (i.e., less than 65% edible oil) may comprise from 10% to 15% acidulant by weight. It will be understood by one having ordinary skill in the art that the amount of acidulant may vary due to the various concentrations of acidulant available. For example, vinegars may be commercially available in concentrations ranging from 5% to 30% acetic acid and may be diluted to a concentration as desired.

According to other embodiments, the composition may further comprise a food starch. For example, according to the FDA, salad dressings may comprise a starchy paste (21 C.F.R. § 169.150(a)). Starches may be used in the composition, for example, as a thickener, a stabilizer, a texturizer, or combinations thereof. Starches may also contribute to the “mouth feel” of the composition (i.e., provide the composition with a mouth feel substantially similar to that of an egg protein-containing mayonnaise or salad dressing). Starches suitable for use in various embodiments of the present compositions may be either a cook-up starch (i.e., a starch that typically will not swell prior to exposure to heat) or an instant starch (i.e., a starch that will swell after contact with a cold aqueous solution). Starches suitable for use in various embodiments of the present disclosure include, for example, wheat starch, corn starch, tapioca, potato starch, rice starch, sago starch, and combinations of any thereof. The various starches listed herein also include modified versions of the listed starches, such as, starches that have been chemically or physically modified, for example, by reaction with a chemical, such as, an acid, a reducing agent, and/or an enzyme, or by heating. Starch usage levels may vary depending on the level of edible oil in the composition. For example, compositions with greater levels of oil may have higher viscosities and therefore require lower starch levels, whereas reduced levels of oils may require higher starch levels. According to certain embodiments, compositions disclosed herein may comprise from 0% to 10% by weight of starch. According to other embodiments, the compositions may comprise from 1% to 10% by weight of starch.

According to certain embodiments, the compositions disclosed herein may further comprise a sweetener. Sweeteners may be added to the composition to provide a desired flavor. Sweeteners suitable for use in the various compositions disclosed herein, include, but are not limited to, sucrose, fructose (including crystalline fructose), glucose, other carbohydrate sweeteners, sugar alcohols, honey, molasses, corn syrup, high fructose corn syrup (“HFCS”), non-nutritive sweeteners, and combinations of any thereof. Non-nutritive sweeteners may include sugar substitutes, such as, for example, sucralose, acesulfame potassium, aspartame, saccharine, neotame, sorbitol, mannitol, lactitol, isomalt, xylitol, maltitol, hydrogenated corn syrup, and combinations of any thereof. According to certain embodiments, compositions disclosed herein may comprise from 1% to 10% by weight of sweetener. As will be understood by one having ordinary skill in the art, many non-nutritive sweeteners may be much sweeter than sugar. Therefore, when non-nutritive sweeteners are incorporated into the compositions disclosed herein, the compositions may comprise from 0.0001% to 6% by weight of the non-nutritive sweetener.

According to certain embodiments, the compositions disclosed herein may further comprise a dietary fiber, such as, a soluble fiber. Soluble fibers may contribute to the texture of the composition, as well as providing the nutritional benefits associated with the increase in dietary fiber. Increased dietary fiber content has been associated with the promotion of intestinal regularity, moderation of post-prandial blood glucose levels and lowering of serum cholesterol and/or triglyceride levels. Soluble fibers are water soluble substances that are not digested by enzymes in the upper digestive tract (including the small intestines) and may pass substantially intact to the large intestines where it may act as a prebiotic for intestinal flora. According to certain embodiments, the compositions may further comprise a soluble fiber selected from the group consisting of a soluble dextrin, inulin, polydextroses, oligofructoses, and combinations of any thereof. As used herein, the term “soluble dextrin” includes, but is not limited to, digestion resistant starches, such as, for example, FIBERSOL® (commercially available from Matsutani Chemical Industry Co., Ltd., Japan), NUTRIOSE® (commercially available from Roquette Frères, France), and the digestion resistant starches produced by the methods described in U.S. Patent Application Publication Nos. US 2004/0167325 and US 2006/0073263, the disclosures of which are incorporated in their entirety by reference herein. According to certain embodiments, compositions disclosed herein may comprise from 0% to 50% by weight of soluble fiber. According to other embodiments, the compositions may comprise from 15% to 45% by weight of soluble fiber. In other embodiments, the soluble fiber may be added to the composition in a quantity necessary to provide from 3 grams to 6 grams of fiber per serving of composition (assuming a serving size of from 10 grams to 20 grams).

According to other embodiments, the compositions described herein may further comprise an emulsifier or a stabilizer. Emulsifiers may help maintain or stabilize the emulsion of edible oil and water. According to certain embodiments, the emulsifier may have a hydrophilic-lipophilic balance (“HLB”) value ranging from 10 to 15. Non-limiting examples of emulsifiers that may be used in various embodiments of the compositions include polysorbate 60, ethoxylated monoglycerides, sucrose esters, propylene glycol monoesters, sorbitan esters, lecithin, and combinations of any thereof. According to certain embodiments, compositions disclosed herein may comprise from 0% to 5% by weight of emulsifier.

According to other embodiments, the compositions disclosed herein may further comprise one or more gums. Gums may be used to alter the viscosity and/or gelling characteristics of the compositions, for example, to give the composition a pleasing texture or mouth feel. Gums may also act as stabilizers and thickeners, as well as providing cling, creaminess and opacity to the compositions. Gums may, for example, act to maintain desired levels of texture in compositions disclosed herein that may have reduced fat levels, such as, compositions with reduced levels of edible oils. In addition, gums may act as stabilizers by preventing coalescence of oil droplet in the emulsion, thus stabilizing the emulsion of oil and water. Gums, including natural and synthetic gums and gels, that may be suitable for use in various embodiments of the compositions set forth herein include, but are not limited to, xanthan gum, carrageenan, guar gum, cellulose gels (including microcrystalline cellulose gels), alginates (such as propylene glycol alginate), gum Arabic, sodium carboxymethylcellulose, locust bean gum, and combinations of any thereof. Combinations of gums may, in certain embodiments, include blends of two or more gums. In certain embodiments, a blend of gums, such as a blend of xanthan gum and a cellulose gel, may be used in the composition. According to certain embodiments, the use of a gum or a blend of gums may allow for the use of lower amounts of wheat protein isolate in the composition. According to certain embodiments, compositions disclosed herein may comprise from 0% to 1.0% by weight of a gum or gum blend. According to other embodiments, the compositions may comprise from 0.05% to 1.0% by weight of a gum or gum blend.

Other embodiments of the compositions may further comprise additional ingredients, such as, spices, herbs, seasonings, food particles, flavorings, sterols, vitamins, colorants, antioxidants and preservatives, and combinations of any thereof.

For example, according to certain embodiments, the compositions may comprise one or more herb, spice, seasoning, and/or flavoring, such as, but not limited to, paprika, dry ground mustard, yellow prepared mustard, Dijon mustard, salt, pepper (such as, black, cayenne, chili, and the like), chili powder, garlic powder, onion powder, celery seed (whole or powdered), horseradish, ginger, turmeric, curry powder, rosemary, monosodium glutamate (“MSG”), parsley, lemon zest, lime zest, orange zest, seasoning salt, ketchup, dill, and combinations of any thereof. According to certain embodiments, compositions disclosed herein may comprise from 0% to 5.0% by weight of one or more herbs, spices, and flavorings. According to other embodiments, compositions disclosed herein may comprise from 0% to 2.0% by weight of one or more herbs, spices, and flavorings.

According to other embodiments, the compositions may further comprise food particles, such as, for example, onion pieces (including pieces of chives and shallots), garlic, chopped pickles (including sweet and dill varieties), fruit pieces, vegetable pieces (including, but not limited to, carrot pieces, celery pieces, bell pepper pieces, lettuce pieces, cucumber pieces, tofu pieces, tomato pieces, and the like), chopped olives, capers, nut pieces, cheese pieces, meat pieces (including, but not limited to, fish, such as tuna, chicken, bacon or other pork meat, and beef), boiled egg pieces, and combinations of any thereof. For example, a tartar sauce comprising the compositions disclosed herein may comprise chopped dill pickle and chopped onion. In another example, the composition may comprise a sandwich spread including vegetable pieces such as celery, onion, carrots, garlic, and/or pepper. The amount of the food particles present in the food composition may vary depending on the particular features desired and certain embodiments may include up to 80% by weight of food particles. In other embodiments, the composition may comprise from 1% to 50% by weight of food particles.

According to other embodiments, the compositions may further comprise at least one sterol and/or vitamin, such as, but not limited to, the A vitamins, the B vitamin (such as, niacin, thiamine, riboflavin, folate), vitamin C, the D vitamins, the E vitamins (including tocopherols), sterols (such as, phytosterols and ergosterols) and combinations of any thereof. Vitamins and sterols may be added to the compositions in such an amount as to provide, for example, an amount sufficient to provide at least a portion of the recommended dietary allowances (“RDA”) as set forth by United States Department of Agriculture (“USDA”). According to other embodiments, the compositions may further comprise a preservative and/or antioxidant, such as, but not limited to, potassium sorbate, ethylenediaminetetraacetic acid (“EDTA”), butylated hydroxytoluene (“BHT”), butylated hydroxyanisol (“BHA”), tertiary butylhydroquinone (“TBHQ”), tocopherols, and combinations of any thereof. The various preservatives and/or antioxidants listed herein may be added to the compositions in amounts sufficient to increase shelf life, such as, by preventing spoilage and/or oxidation of the composition. According to certain embodiments, the preservatives and/or antioxidants may be added to the composition in an amount of 0% to 0.1% by weight of the composition.

Still other embodiment of the present disclosure may comprise a composition configured as a dressing, a mayonnaise substitute, or a spread. The composition may comprise a whole bean powder, an edible oil (as described herein), and water. Suitable whole bean powders include, but are not limited to, whole soybean powders, such as, NUTRISOY® Bean Powder or MIDLAND HARVEST® Whole Bean Powder, both of which are commercially available from Archer Daniels Midland Company, Decatur, Ill. The compositions according to these embodiments may further comprise additional ingredients such as food starches, sweeteners, acidulants, spices, seasonings, food pieces, stabilizers, antioxidants, sterols, soluble fiber, gums, emulsifiers, flavorings, whole soybean powder, preservatives, colorants, and various combinations of any thereof as set forth and described herein.

Other embodiments of the present disclosure comprise methods and processes for forming the compositions described herein. For example, according to certain embodiments, the present disclosure provides a process for producing a food product comprising mixing a wheat protein isolate, which may be in the form of a dry mix, with water, thus forming a protein slurry and blending an edible oil into the protein slurry, thus forming a food product. According to other embodiments, the process may comprise mixing at least one additional ingredient with the wheat protein isolate. Additional ingredients may include, for example, but not limited to, a whey protein isolate, a food starch, a sweetener, a spice, a stabilizer, an antioxidant, a sterol, a soluble fiber, a gum, an emulsifier, a flavoring, whole soybean powder, and combinations of any thereof. Various non-limiting suitable embodiments of the additional ingredients are described herein.

In still other embodiments, the process may comprise blending an acidulant into the food composition. For example, blending an acidulant may comprise blending one or more of a vinegar, lemon juice, lime juice, or any other suitable acidulant described herein, into the food composition. The acidulant may be blended into the protein slurry or into the emulsion formed between the protein slurry and the edible oil.

According to various embodiments of the process, the wheat protein isolate, the water and the edible oil may be present in the food product in such amounts that the food product is in a form of, for example, a dressing, such as a salad dressing or spoonable salad dressing, a mayonnaise substitute, such as a full-fat, reduced-fat, or low-fat mayonnaise substitute, or a spread, such as a sandwich spread or bread spread. In certain embodiments of the process, the food composition may be an egg-free mayonnaise substitute, an egg-free salad dressing, or an egg-free spread.

According to other embodiments, the process for producing a food product may comprise cooking the food product. In certain embodiments, cooking the food product may include pasteurizing the food product.

In certain embodiments, the process for producing a food product may comprise placing the food product in a container configured for shipping, associating indicia with the container, and shipping the container. The indicia associated with the container may include indicia configured to identify the contents of the container, identify nutritional information of the food product, and combinations thereof. Shipping the container may be by any standard method of shipping, for example, by truck or transport, by rail, by air, and/or by sea. In other embodiments, the process may comprise placing the food product in a container configured for shipping; and associating indicia with the container, wherein the indicia indicates that the food product therein is an egg-free food product.

In certain processes for producing the food product, mixing the wheat protein isolate, which may be in the form of a dry mix, with water to form a protein slurry may include cooling the protein slurry. In certain embodiments, cooling the protein slurry may include cooling the protein slurry to a temperature from 0° C. to 25° C. For example, cooling the protein slurry may include cooling the mixing vessel in which the dry mix and the water are combined to form the slurry. Cooling the protein slurry may be effected using, but not limited to, cooling with a mixture of ice and water.

Other embodiments within the scope of the present disclosure include a product produced by any of the processes described herein. For example, in one embodiment, the present disclosure includes a food product produced by the process comprising mixing a dry mix comprising a wheat protein isolate with water to form a protein slurry, and blending an edible oil into the protein slurry to form the food product.

Other embodiments of the present disclosure include a food composition configured as a dressing, such as a salad dressing or a spoonable salad dressing; or a spread, such as a bread or sandwich spread. The food composition may comprise 1% to 5% by weight of a wheat protein isolate, 5% to 75% by weight of an edible oil, and 15% to 50% by weight of water. According to certain embodiments, the food product may comprise from 1% to 5% by weight of a whey protein isolate, as described herein.

According to other embodiments, the food product, as described herein, may be configured as a mayonnaise or a mayonnaise substitute, for example a full-fat mayonnaise or mayonnaise substitute. According to these embodiments the mayonnaise or mayonnaise substitute may comprise 1% to 5% by weight of a blend of a wheat protein isolate and a whey protein isolate, 45% to 75% by weight of an edible oil, and 15% to 50% by weight of water. According to other embodiments, the food product may be configured as a reduced-fat mayonnaise or mayonnaise substitute. According to these embodiments, the mayonnaise or mayonnaise substitute may comprise 1% to 5% by weight of a wheat protein isolate, 15% to 50% by weight of an edible oil, and 10% to 50% by weight of water.

According to various embodiments of the food products described herein the edible oil may be any of the edible oils set forth herein. In other embodiments, the food product may comprise other ingredients, such as, for example, any of the additional ingredients set forth herein. In certain embodiments, the food product may comprise a gum selected from the group consisting of xanthan gum, carrageenan, guar gum, locust bean gum, tara gum, a cellulose gel (such as a microcrystalline cellulose gel), propylene glycol alginate, gum Arabic, sodium carboxymethylcellulose, and combinations of any thereof.

Still other embodiments, of the present disclosure include a composition comprising at least one of a wheat protein isolate and whole bean powder, and edible oil, and water, wherein the composition is substantially free of egg protein. As used herein, whole bean powder includes a full-fat whole soybean powder, such as, NUTRISOY® Bean Powder or MIDLAND HARVEST® Whole Bean Powder, both of which are commercially available from Archer Daniels Midland Company, Decatur, Ill. According to certain embodiments, the whole bean powder may be produced by the methods as set forth in U.S. Patent Application Publication Nos. US 2004/0197463 and US 2006/0062891, the disclosures of which are incorporated in their entirety by reference herein.

Various embodiments of the present disclosure will be better understood when read in conjunction with the following non-limiting Examples. The procedures set forth in the Examples below are not intended to be limiting herein, as those skilled in the art will appreciate that various modifications to the procedures set forth in the Examples, as well as to other procedures not described in the Examples, may be useful in practicing the invention as described herein and set forth in the appended claims.

### EXAMPLES

### Example 1

### Egg-Free Full Fat Mayonnaise Substitute

An egg-free full fat mayonnaise substitute was prepared using a blend of wheat protein isolate and whey protein isolate, soybean oil, and water. The composition of the spread is presented in Table 1.

TABLE 1
Ingredients for Egg-Free Full Fat Mayonnaise Substitute

| Ingredients | Weight (grams) | Weight Percent |
|---|---|---|
| Soybean oil | 1400.00 | 70.00% |
| Wheat protein isolate | 25.00 | 1.25% |
| Whey protein isolate | 25.00 | 1.25% |
| ADM Gum blend | 3.00 | 0.15% |
| Crystalline fructose | 32.80 | 1.64% |
| Distilled vinegar (50 grain) | 50.00 | 2.50% |
| Lemon juice | 40.00 | 2.00% |
| EDTA | 0.10 | 0.005% |
| Potassium sorbate | 0.60 | 0.03% |
| Salt | 30.00 | 1.50% |
| Yellow prepared mustard | 5.00 | 0.25% |
| Water | 388.50 | 19.425% |
| Total | 2000.00 | 100.00% |

The egg-free full fat mayonnaise substitute was prepared by the following procedure. Water (300 g) was added to a high speed mixer bowl with cooling jacket having a mixture of ice and water running through the jacket. The wheat protein isolate (25 g, PROLITE® 100, commercially available from Archer Daniels Midland Company, Decatur, Ill.) and the whey protein isolate (25 g, PROVON® 190, commercially available from Glanbia Nutritionals, Monroe, Wis.) were added to the water and mixed at low speed (speed 3-5) for 1 minute. The sides of the bowl were scraped and the mixture was mixed at medium speed (speed 9) for 5 minutes. The soybean oil (1400 g) was slowly added, scraping the sides of the mixing bowl half-way through the addition and again at the end of the oil addition. A dry blend of xanthan gum and microcrystalline cellulose (3 g), crystalline fructose (32.8 g), EDTA (0.1 g), and potassium sorbate (0.6 g) was formed and added slowly to the mixture with continued mixing at medium speed (speed 9) for 1 minute. A slurry of the yellow prepared mustard (5 g), salt (30 g), and the remaining water (88.5 g) was formed and added to the mixture. Vinegar (50 g) and lemon juice (40 g) were added to the mixture and the composition was mixed at high speed (speed 12) for 2 minutes.

The resulting egg-free spread was comparable to commercially available mayonnaise in texture, color and flavor. The egg-free spread had the following nutritional values for a serving size of 15 g: 100 calories (90 calories from fat); 11 g total fat (17% daily value), with 1.5 g saturated fat (8% daily value) and 0 g trans fat; 0 mg cholesterol; 90 mg sodium (4% daily value); 0 g total carbohydrate (0 g dietary fiber and 0 g sugars); and 0 g protein. The percent daily values were based on a 2,000 calorie diet.

### Example 2

### Egg-Free 70% Fat Mayonnaise Substitute

An egg-free 70% fat mayonnaise substitute was prepared using a blend of wheat protein isolate and whey protein isolate, soybean oil, and water. The composition of the spread is presented in Table 2.

TABLE 2
Ingredients for Egg-Free 70% Fat Mayonnaise Substitute

| Ingredients | Weight (grams) | Weight Percent |
|---|---|---|
| Soybean oil | 1400.00 | 70.00% |
| Wheat protein isolate | 25.00 | 1.25% |
| Whey protein isolate | 25.00 | 1.25% |
| Xanthan gum | 0.75 | 0.037% |
| Microcrystalline | 2.25 | 0.113% |
| cellulose gel | | |
| Crystalline fructose | 32.80 | 1.64% |
| Distilled vinegar (50 grain) | 50.00 | 2.50% |
| Lemon juice | 40.00 | 2.00% |
| EDTA | 0.10 | 0.005% |
| Potassium sorbate | 0.60 | 0.03% |
| Salt | 30.00 | 1.50% |
| Yellow prepared mustard | 5.00 | 0.25% |
| Water | 388.50 | 19.425% |
| Total | 2000.00 | 100.00% |

The egg-free full fat mayonnaise substitute was prepared by the following procedure. Water (300 g) was added to a high speed mixer bowl with cooling jacket having a mixture of ice and water running through the jacket. The wheat protein isolate (25 g, PROLITE® 100, commercially available from Archer Daniels Midland Company, Decatur, Ill.) and the whey protein isolate (25 g, PROVON® 190, commercially available from Glanbia Nutritionals, Monroe, Wis.) were added to the water and mixed at low speed (speed 3-5) for 1 minute. The sides of the bowl were scraped and the mixture was mixed at medium speed (speed 9) for 5 minutes. The soybean oil (1400 g) was slowly added, scraping the sides of the mixing bowl half-way through the addition and again at the end of the oil addition. A dry blend of xanthan gum (0.75 g), microcrystalline cellulose gel (2.25 g, AVICEL® RC-591 F, commercially available from FMC Biopolymer, Philadelphia, Pa.), crystalline fructose (32.8 g), EDTA (0.1 g), and potassium sorbate (0.6 g) was formed and added slowly to the mixture with continued mixing at medium speed (speed 9) for 1 minute. A slurry of the yellow prepared mustard (5 g), salt (30 g), and the remaining water (88.5 g) was formed and added to the mixture. Vinegar (50 g) and lemon juice (40 g) were added to the mixture and the composition was mixed at high speed (speed 12) for 2 minutes.

The resulting egg-free spread was comparable to commercially available mayonnaise in texture, color and flavor. The egg-free spread had the following nutritional values for a serving size of 15 g: 100 calories (90 calories from fat); 11 g total fat (17% daily value), with 1.5 g saturated fat (8% daily value) and 0 g trans fat; 0 mg cholesterol; 90 mg sodium (4% daily value); 0 g total carbohydrate (0 g dietary fiber and 0 g sugars); and 0 g protein. The percent daily values were based on a 2,000 calorie diet.

### Example 3

### Egg-Free Full Fat Mayonnaise Substitute Made With DAG Oil

An egg-free diacylglyceride containing mayonnaise substitute was prepared using a blend of wheat protein isolate and whey protein isolate, DAG oil, and water. The composition of the spread is presented in Table 3.

TABLE 3
Ingredients for Egg-Free Mayonnaise Substitute Comprising DAG Oil

| Ingredients | Weight (grams) | Weight Percent |
|---|---|---|
| Enova DAG oil | 1400.00 | 70.00% |
| Wheat protein isolate | 50.00 | 2.50% |
| Whey protein isolate | 50.00 | 2.50% |
| Xanthan gum | 1.50 | 0.075% |
| Microcrystalline | 4.50 | 0.23% |
| cellulose gel | | |
| Crystalline fructose | 32.80 | 1.64% |
| Distilled vinegar (50 grain) | 50.00 | 2.50% |
| Lemon juice | 40.00 | 2.00% |
| EDTA | 0.10 | 0.005% |
| Potassium sorbate | 0.60 | 0.03% |
| Salt | 30.00 | 1.50% |
| Yellow prepared mustard | 5.00 | 0.25% |
| Water | 335.50 | 16.77% |
| Total | 2000.00 | 100.00% |

The egg-free DAG oil full fat mayonnaise substitute was prepared by the following procedure. Water (300 g) was added to a high speed mixer bowl with cooling jacket having a mixture of ice and water running through the jacket. The wheat protein isolate (50 g, PROLITE® 100, commercially available from Archer Daniels Midland Company, Decatur, Ill.) and the whey protein isolate (50 g, PROVON® 190, commercially available from Glanbia Nutritionals, Monroe, Wis.) were added to the water and mixed at low speed (speed 3-5) for 1 minute. The sides of the bowl were scraped and the mixture was mixed at medium speed (speed 9) for 5 minutes. ENOVA® brand DAG oil (1400 g, commercially available from ADM Kao, Decatur, Ill.) was slowly added, scraping the sides of the mixing bowl half-way through the addition and again at the end of the oil addition. A dry blend of xanthan gum (1.5 g), microcrystalline cellulose gel (4.5 g, AVICEL® RC-591 F, commercially available from FMC Biopolymer, Philadelphia, Pa.), crystalline fructose (32.8 g), EDTA (0.1 g), and potassium sorbate (0.6 g) was formed and added slowly to the mixture with continued mixing at medium speed (speed 9) for 1 minute. A slurry of the yellow prepared mustard (5 g), salt (30 g), and the remaining water (35.5 g) was formed and added to the mixture. Vinegar (50 g) and lemon juice (40 g) were added to the mixture and the composition was mixed at high speed (speed 12) for 2 minutes.

The resulting egg-free spread containing DAG oil was comparable to commercially available mayonnaise in texture, color and flavor. The egg-free spread containing DAG oil had the following nutritional values for a serving size of 15 g: 100 calories (90 calories from fat); 11 g total fat (17% daily value), with 0 g saturated fat and 0 g trans fat; 0 mg cholesterol; 90 mg sodium (4% daily value); 0 g total carbohydrate (0 g dietary fiber and 0 g sugars); and 1 g protein. The percent daily values were based on a 2,000 calorie diet.

### Example 4

### Egg-Free Reduced Fat Spread

An egg-free reduced fat spread was prepared using a wheat protein isolate, soybean oil, and water. The composition of the spread is presented in Table 4.

TABLE 4
Ingredients in Egg-Free Reduced Fat Spread

| Ingredients | Weight (grams) | Weight Percent |
|---|---|---|
| Soybean oil | 300.00 | 30.00% |
| Wheat protein isolate | 40.00 | 4.00% |
| Apple cider vinegar | 60.00 | 6.00% |
| (50 grain) | | |
| Lemon juice | 60.00 | 6.00% |
| Crystalline fructose | 32.18 | 3.217% |
| Xanthan gum | 4.00 | 0.40% |
| Dry ground mustard | 5.00 | 0.50% |
| Modified tapioca starch | 5.00 | 0.50% |
| Wheat starch | 35.00 | 3.50% |
| EDTA | 0.07 | 0.007% |
| Salt | 10.00 | 1.00% |
| Tocopherols | 0.30 | 0.03% |
| Potassium sorbate | 0.50 | 0.05% |
| Water | 447.95 | 44.796% |
| Total | 1000.00 | 100.00% |

The egg-free reduced fat spread was prepared by the following procedure. Water (47.95 g), AYTEX® P brand wheat starch (35 g, commercially available from Archer-Daniels-Midland Company, Decatur, Ill.), and ULTRA TEX 3 brand modified tapioca starch (5 g, cold water swelling, commercially available from National Starch and Chemical Co., Bridgewater, N.J.) were placed in a heat stable pan and stirred until well dissolved. The solution was heated to a temperature of 90° C. and cooled to approximately 20° C. over an ice bath with occasional stirring. The starch mixture was transferred to a Hobart mixing bowl equipped with a whisk and stirred at medium speed (speed 8). The dry components, wheat protein isolate (40 g, PROLITE® 100, commercially available from Archer Daniels Midland Company, Decatur, Ill.), crystalline fructose (32.18 g), NOVAXAN® 200 brand xanthan gum (4 g, commercially available from Archer-Daniels-Midland Company, Decatur, Ill.), dry ground mustard (5 g), EDTA (0.07 g), salt (10 g), DECONOX™ MTS-30P brand tocopherol mixture (0.3 g, commercially available from Archer-Daniels-Midland Company, Decatur, Ill.), and potassium sorbate (0.5 g) were added to the starch solution and mixed at medium speed (speed 8). While continuing to mix at medium speed (speed 8), soybean oil (300 g) was slowly added in a steady stream over approximately 30 seconds. After the oil was incorporated into the mixture, the sides of the bowl were scraped down and the mixture was mixed for an additional minute at medium speed (speed 8). The apple cider vinegar (60 g) and lemon juice (60 g) were added to the mixture and the composition was mixed for 1-2 minutes. The egg-free reduced fat spread was packaged and placed in a cooler at 38° C. to 42° C. for 24 hr before evaluation.

The resulting egg-free reduced fat spread was comparable to commercially available sandwich spreads, such as Hellman's Reduced Fat spread or Miracle Whip® spread, in texture, color and flavor. The egg-free reduced fat spread had the following nutritional values for a serving size of 15 g: 45 calories (40 calories from fat); 4.5 g total fat (7% daily value), with 0.5 g saturated fat (3% daily value) and 0 g trans fat; 0 mg cholesterol; 65 mg sodium (3% daily value); 1 g total carbohydrate, including 0 g dietary fiber and 1 g sugars; and 1 g protein. The percent daily values were based on a 2,000 calorie diet.

### Example 5

### Whole Bean Powder-Based Egg-Free Spread

An egg-free reduced fat spread was prepared using a whole soybean powder, soybean oil, and water. The composition of the spread is presented in Table 5.

TABLE 5
Ingredients in Egg-Free Whole Bean Powder Reduced Fat Spread

| Ingredients | Weight (grams) | Weight Percent |
|---|---|---|
| Soybean oil | 300.00 | 30.00% |
| Whole soybean powder | 85.00 | 8.50% |
| Vinegar (50 grain) | 80.00 | 8.00% |
| Garlic powder | 0.05 | 0.005% |
| Lemon juice | 50.00 | 5.00% |
| Crystalline fructose | 55.00 | 5.50% |
| Xanthan gum | 2.00 | 0.20% |
| Dry ground mustard | 3.00 | 0.30% |
| Onion powder | 1.00 | 0.10% |
| Corn starch | 30.00 | 3.00% |
| EDTA | 0.07 | 0.007% |
| Salt | 10.00 | 1.00% |
| Tocopherols | 0.30 | 0.03% |
| Celery seed powder | 0.02 | 0.002% |
| Paprika | 0.10 | 0.01% |
| Potassium sorbate | 0.50 | 0.05% |
| Water | 382.96 | 38.296% |
| Total | 1000.00 | 100.00% |

The egg-free reduced fat whole bean powder-based spread was prepared as follows. Water (382.96 g) was added to a food processor. A dry blend of the dry ingredients, MIDLAND HARVEST® brand whole soybean powder (85 g, formally known as NUTRISOY® brand whole soybean powder, commercially available from Archer Daniels Midland Company, Decatur, Ill.), garlic powder (0.05 g), crystalline fructose (55 g), NOVAXAN® 200 brand xanthan gum (2 g, commercially available from Archer-Daniels-Midland Company, Decatur, Ill.), dry ground mustard (3 g), onion powder (1 g), Ultrasperse M brand corn starch (30 g, commercially available from National Starch and Chemical Co., Bridgewater, N.J.), EDTA (0.07 g), salt (10 g), DECONOX™ MTS-30P brand tocopherol mixture (0.3 g, commercially available from Archer-Daniels-Midland Company, Decatur, Ill.), celery seed powder (0.02 g), paprika (0.1 g), and potassium sorbate (0.5 g) was slowly added to the water in the food processor. The composition was mixed for 30 seconds, the sides were scraped down, and the composition was mixed for an additional 10 seconds. Soybean oil (300 g) was slowly added to the mixture over 30 seconds with the food processor mixing. The sides of the food processor were scraped down and the composition mixed an additional 10 seconds. The vinegar (80 g) and lemon juice (50 g) were added to the composition while slowly mixing and the composition was mixed for an additional 10 seconds until a uniform consistency was achieved. Care was taken not to over mix at this point. The spread was packaged and placed in a refrigerator at 38° C. to 42° C. for 24 hr before evaluation.

The resulting whole soybean powder egg-free reduced fat spread was comparable to commercially available sandwich spreads, such as Hellman's Reduced Fat spread or Miracle Whip® spread, in texture, color and flavor. The whole soybean powder egg-free reduced fat spread had the following nutritional values for a serving size of 15 g: 50 calories (40 calories from fat); 5 g total fat (8% daily value), with 0.5 g saturated fat (3% daily value) and 0 g trans fat; 0 mg cholesterol; 60 mg sodium (3% daily value); 2 g total carbohydrate (1% daily value), including 0 g dietary fiber and 1 g sugars; and 1 g protein. The percent daily values were based on a 2,000 calorie diet.

In a second example of the egg-free reduced fat spread made with whole soybean powder, a composition was prepared having a composition as set forth in Table 5 except the garlic powder, onion powder, celery seeds (ground), and paprika were omitted. The resulting whole soybean powder egg-free reduced fat spread was comparable to commercially available sandwich spreads, such as Hellman's Reduced Fat spread or Miracle Whip® spread, in texture, color and flavor. The whole soybean powder egg-free reduced fat spread had the same nutritional values as set forth above.

In a third example of the egg-free reduced fat spread made with whole soybean powder, a composition was prepared having a composition as set forth in Table 5 except the garlic powder, onion powder, celery seeds (ground), and paprika were omitted and DECONOX™ MTS-90 brand tocopherol mixture (0.3 g, commercially available from Archer-Daniels-Midland Company, Decatur, Ill.) was added instead of DECONOX™ MTS-30P. The resulting whole soybean powder egg-free reduced fat spread was comparable to commercially available sandwich spreads, such as Hellman's Reduced Fat spread or Miracle Whip® spread, in texture, color and flavor. The whole soybean powder egg-free reduced fat spread had the same nutritional values as set forth above.

### Example 6

### Egg-Free Spread Made With Soy Protein Isolate

An egg-free reduced fat spread was prepared using a soy protein isolate, soybean oil, and water. The composition of the spread is presented in Table 6.

TABLE 6
Ingredients in Egg-Free Soy Protein Isolate Reduced Fat Spread

| Ingredients | Weight (grams) | Weight Percent |
|---|---|---|
| Soybean oil | 300.00 | 30.00% |
| Soy protein isolate | 40.00 | 4.00% |
| Apple cider vinegar | 60.00 | 6.00% |
| (50 grain) | | |
| Lemon juice | 60.00 | 6.00% |
| Crystalline fructose | 32.18 | 3.217% |
| Xanthan gum | 4.00 | 0.40% |
| Dry ground mustard | 5.00 | 0.50% |
| Wheat starch | 40.00 | 4.00% |
| EDTA | 0.07 | 0.007% |
| Salt | 10.00 | 1.00% |
| Tocopherols | 0.30 | 0.03% |
| Potassium sorbate | 0.50 | 0.05% |
| Water | 447.95 | 44.796% |
| Total | 1000.00 | 100.00% |

The egg-free reduced fat spread was prepared by the following procedure. Water (47.95 g) and AYTEX® P brand wheat starch (40 g, commercially available from Archer-Daniels-Midland Company, Decatur, Ill.) were placed in a heat stable pan and stirred until well dissolved. The solution was heated to a temperature of 90° C. and cooled to approximately 20° C. over an ice bath with occasional stirring. The starch mixture was transferred to a Hobart mixing bowl equipped with a whisk and stirred at medium speed (speed 8). The dry components, PROFAM™ 781 brand soy protein isolate (40 g, commercially available from Archer Daniels Midland Company, Decatur, Ill.), crystalline fructose (32.18 g), NOVAXAN® 200 brand xanthan gum (4 g, commercially available from Archer-Daniels-Midland Company, Decatur, Ill.), dry ground mustard (5 g), EDTA (0.07 g), salt (10 g), DECONOX™ MTS-30P brand tocopherol mixture (0.3 g, commercially available from Archer-Daniels-Midland Company, Decatur, Ill.), and potassium sorbate (0.5 g) were added to the starch solution and mixed at medium speed (speed 8). While continuing to mix at medium speed (speed 8), soybean oil (300 g) was slowly added in a steady stream over approximately 30 seconds. After the oil was incorporated into the mixture, the sides of the bowl were scraped down and the mixture mixed for an additional minute at medium speed (speed 8). The apple cider vinegar (60 g) and lemon juice (60 g) were added to the mixture and the composition was mixed for 1-2 minutes. The egg-free reduced fat spread was packaged and placed in a cooler at 38° C. to 42° C. for 24 hr before evaluation.

The resulting soy protein isolate egg-free reduced fat spread was comparable to commercially available sandwich spreads, such as Hellman's Reduced Fat spread or Miracle Whip® spread, in texture, color and flavor. The soy protein isolate egg-free reduced fat spread had the following nutritional values for a serving size of 15 g: 45 calories (40 calories from fat); 4.5 g total fat (7% daily value), with 0.5 g saturated fat (3% daily value) and 0 g trans fat; 0 mg cholesterol; 65 mg sodium (3% daily value); 1 g total carbohydrate, including 0 g dietary fiber and 1 g sugars; 1 g protein; and 10% daily value of vitamin B12. The percent daily values were based on a 2,000 calorie diet.

In a second example of the egg-free reduced fat spread made with soy protein isolate, a composition was prepared having a composition as set forth in Table 6 except the DECONOX™ MTS-90 brand tocopherol mixture (0.3 g, commercially available from Archer-Daniels-Midland Company, Decatur, Ill.) was added instead of DECONOX™ MTS-30P. The resulting soy protein isolate egg-free reduced fat spread was comparable to commercially available sandwich spreads, such as Hellman's Reduced Fat spread or Miracle Whip® spread, in texture, color and flavor. The soy protein isolate egg-free reduced fat spread had the same nutritional values as set forth above.

Although the foregoing description has necessarily presented a limited number of exemplary embodiments of the invention, those of ordinary skill in the relevant art will appreciate that various changes in the components, details, materials, and process parameters of the examples that have been herein described and illustrated in order to explain the nature of the invention may be made by those skilled in the art, and all such modifications will remain within the principle and scope of the invention as expressed herein in the appended claims. It will also be appreciated by those skilled in the art that changes could be made to the embodiments described above without departing from the broad inventive concept thereof. It is understood, therefore, that this invention is not limited to the particular embodiments disclosed, but it is intended to cover modifications that are within the principle and scope of the invention, as defined by the claims.

We claim:

1. A composition comprising:
a wheat protein isolate;
an edible oil; and
water.

2. The composition of claim 1, wherein the wheat protein isolate, the edible oil, and the water are present in the composition in amounts such that the composition is in a form selected from the group consisting of a dressing, a mayonnaise substitute, and a spread.

3. The composition of claim 1, further comprising a protein selected from the group consisting of whey protein, soy protein, whole soybean protein, milk protein, safflower protein, canola protein, an egg protein, isolates of any thereof, concentrates of any thereof, and combinations of any thereof.

4. The composition of claim 1, wherein the edible oil is selected from the group consisting of corn oil, soybean oil, canola oil, vegetable oil, safflower oil, sunflower oil, nasturtium seed oil, mustard seed oil, olive oil, sesame oil, peanut oil, cottonseed oil, rice bran oil, babassu nut oil, castor oil, palm oil, palm kernel oil, rapeseed oil, low erucic acid rapeseed oil, lupin oil, jatropha oil, coconut oil, flaxseed oil, evening primrose oil, jojoba oil, cocoa butter, a low trans-fatty acid oil, a diacylglycerol oil, fractions of any thereof, and mixtures of any thereof.

5. The composition of claim 1, further comprising an ingredient selected from the group consisting of a food starch, a sweetener, an acidulant, a spice, a stabilizer, an antioxidant, a sterol, a soluble fiber, a gum, an emulsifier, a flavoring, whole soybean powder, a preservative, a colorant, and combinations of any thereof.

6. The composition of claim 1, further comprising an acidulant selected from the group consisting of vinegar, lemon juice, lime juice, citric acid, ascorbic acid, malic acid, fumaric acid, lactic acid, adipic acid, acetic acid, benzoic acid, tartaric acid, and combinations of any thereof.

7. The composition of claim 1, further comprising a sweetener selected from the group consisting of sucrose, fructose, a carbohydrate, a sugar alcohol, corn syrup, high fructose corn syrup, a non-nutritive sweetener, and combinations of any thereof.

8. The composition of claim 1, further comprising a food starch selected from the group consisting of a wheat starch, a corn starch, tapioca, potato starch, rice starch, sago, modified versions of any thereof, and combinations of any thereof.

9. The composition of claim 1, further comprising a soluble fiber selected from the group consisting of a soluble dextrin, inulin, polydextrose, oligofructose, and combinations thereof.

10. The composition of claim 1, further comprising an emulsifier selected from the group consisting of polysorbate 60, an ethoxylated monoglyceride, a sucrose ester, a propylene glycol monoester, a sorbitan ester, lecithin, and combinations of any thereof.

11. The composition of claim 1, wherein:
the wheat protein isolate comprises from 1% to 5% by weight of the composition;
the edible oil comprises from 5% to 75% by weight of the composition; and
water comprises from 15% to 50% by weight of the composition.

12. A process for producing a food product comprising:
mixing a wheat protein isolate with water, thus forming a protein slurry; and
blending an edible oil into the protein slurry, thus forming a food product.

13. The process of claim 12, further comprising mixing an ingredient selected from the group consisting of a whey protein isolate, a food starch, a sweetener, a spice, a stabilizer, an antioxidant, a sterol, a soluble fiber, a gum, an emulsifier, a flavoring, whole soybean powder, and combinations of any thereof with the wheat protein isolate.

14. The process of claim 12, further comprising blending an acidulant into the food composition.

15. The process of claim 12, further comprising cooking the food product.

16. The process of claim 12, wherein the wheat protein isolate, the water, and the edible oil are present in the food product in such amounts that the food product is in a form selected from the group consisting of a dressing, a mayonnaise substitute, and a spread.

17. The process of claim 12, further comprising:
placing the food product in a container configured for shipping;
associating indicia configured to identify the contents of the container, identify nutritional information of the food product, and combinations thereof with the container; and
shipping the container.

18. The process of claim 12, further comprising:
placing the food product in a container configured for shipping; and
associating indicia with the container indicating that the food product is an egg-free food product.

19. The process of claim 12, further comprising cooling the protein slurry.

20-26. (canceled)

27. A composition comprising:
at least one of a wheat protein isolate and whole bean powder;
an edible oil; and
water,
wherein the composition is substantially free of egg protein and is configured as a dressing, a mayonnaise substitute, or a spread.

28-29. (canceled)
